(19) United States
(12) Patent Application Publication
(10) Pub. No.: US 2014/0365167 A1
(43) Pub. Date: Dec. 11, 2014

(54) ANGLE DETECTION DEVICE AND ANGLE DETECTION METHOD

(71) Applicant: Fumihiro SHIMIZU, Kanagawa (JP)

(72) Inventor: Fumihiro SHIMIZU, Kanagawa (JP)

(73) Assignee: Ricoh Company, Limited, Tokyo (JP)

(21) Appl. No.: 14/288,799

(22) Filed: May 28, 2014

(30) Foreign Application Priority Data
Jun. 7, 2013 (JP) 2013-121024

(51) Int. Cl. G01B 7/30

(52) U.S. Cl. CPC G01B 7/30
USPC 702/151

(57) ABSTRACT

An angle detection device includes a vector generating unit that generates a vector based on the sine wave signals output by a plurality of sensors, a vector rotating unit that rotate the vector based on the vector and reference sine waves with different phases, a sign determining unit that determines whether the rotated vector is located in a positive direction or in a negative direction with respect to a predetermined reference angle and outputs a result of determination as a sign determination signal, and an angle counter that increments or decrements a count value of angular data of a predetermined bit length based on the sign determination signal, and outputs the count value as angular data. A deadband with a predetermined reference angle as a center is provided for a process performed by the sign determining unit to determine one of the positive direction and the negative direction.

### CROSS-REFERENCE TO RELATED APPLICATIONS

The present application claims priority to and incorporates by reference the entire contents of Japanese Patent Application No. 2013-121024 filed in Japan on Jun. 7, 2013.

### BACKGROUND OF THE INVENTION

1. Field of the Invention

The present invention relates to an angle detection device and an angle detection method.

2. Description of the Related Art

As a method to detect a rotation angle of a rotating body, there is a known method to provide a rotating body including a permanent magnet, fixedly arrange a magnetic sensor near the rotating body, rotate the rotating body and the magnetic sensor relative to each other, and detect the rotation angle based on an output waveform of the magnetic sensor that changes with the rotation.

For example, as illustrated in FIG. 15, an angle detection device includes, as an object to be detected, a rotating body 06 in which a south pole and a north pole of a permanent magnet are alternately arranged in a cylindrical shape, and includes an X-phase magnetic sensor 05X and a Y-phase magnetic sensor 05Y fixed at an angle of 90° in a rotation direction near the rotating body 06. In this case, output signals Vx and Vy of the magnetic sensors have a cosine waveform and a sine waveform with respect to a rotation angle θ of the rotating body as indicated by Equation 1 and in FIG. 16. However, in FIG. 16, the amplitudes (Ax and Ay) of the output signals Vx and Vy are assumed to be the same (Ax=Ay). Incidentally, a symbol * in Equation 1 denotes multiplication, and the same applies to other Equations to be described later.

$$\{ \begin{matrix}Vx = Ax * cos ( θ ) \\ Vy = Ay * sin ( θ )\end{matrix} \qquad ( 1 )$$

In this case, if the output signals Vx and Vy of the respective magnetic sensors are detected, as illustrated in FIG. 17, an angle between a vector formed by the detected output signals Vx and Vy on the XY plane and the X-axis corresponds to the rotation angle θ. Therefore, as illustrated in FIG. 17 for example, the vector is rotated in a negative rotation direction until the rotated vector coincides with the X-axis ((Vx, Vy)→(Vx′, Vy′)) by rotation transformation as represented by Equation 2. In this case, a total rotation angle of the vector corresponds to a detected angle. Through the operation as described above, the rotation angle θ of the rotating body is detected.

$$( \begin{matrix}{Vx}^{′} \\ {Vy}^{′}\end{matrix} ) = ( \begin{matrix}cos θ n & sin θ n \\ - sin θ n & cos θ n\end{matrix} ) ( \begin{matrix}Vx \\ Vy\end{matrix} ) \qquad ( 2 )$$

For example, in Japanese Laid-open Patent Publication No. 2010-217150, the operation as described above is implemented by using a 1-bit delta-sigma analog-to-digital (A/D) converter, a data stream calculation, or a low-pass filter.

However, the detected angle is discrete data, the resolution of the detected angle is equal to the angular resolution of rotating the vector, and the rotated vector rarely coincides with the X-axis completely. Therefore, even when the rotating body is stopped, a vector subjected to the rotation transformation changes alternately across the X-axis for each repetition period of an angle detection process, that is, for each sampling period. Therefore, the lowest digit of detected angular data changes for each sampling period. Furthermore, when a pulse signal indicating an angular change is generated based on the angular data, chattering of a pulse signal occurs.

Therefore, it is desirable to provide an angle detection device that prevents angular data detected for each sampling period from changing across a reference angle.

### SUMMARY OF THE INVENTION

It is an object of the present invention to at least partially solve the problems in the conventional technology.

According to an aspect of the present invention, there is provided an angle detection device including: a plurality of sensors, each being configured to output a sine wave signal that changes in a sine waveform according to a rotation angle of a rotating body and that has a different phase depending on an arrangement position of each of the sensors; a vector generating unit that generates a vector based on the sine wave signals output by the sensors; a vector rotating unit that performs a calculation on the vector and reference sine waves with different phases to thereby rotate the vector; a sign determining unit that determines whether the vector rotated by the vector rotating unit is located in a positive direction or in a negative direction with respect to a predetermined reference angle, and outputs a result of the determination as a sign determination signal; and an angle counter that increments or decrements a count value of angular data of a predetermined bit length based on the sign determination signal, and outputs the count value as angular data, wherein a deadband with a predetermined reference angle as a center is provided for a process performed by the sign determining unit to determine one of the positive direction and the negative direction, and when the rotated vector is located in the deadband, the angle counter does not increment or decrement the count value of the angular data.

According to another aspect of the present invention, there is provided an angle detection device including: a plurality of sensors, each being configured to output a sine wave signal that changes in a sine waveform according to a rotation angle of a rotating body and that has a different phase depending on an arrangement position of each of the sensors; a vector generating unit that generates a vector based on the sine wave signals output by the sensors; a vector rotating unit that performs a calculation based on the vector and reference sine waves with different phases to thereby rotate the vector; a sign determining unit that determines whether the vector rotated by the vector rotating unit is located in a positive direction or a negative direction with respect to a predetermined reference angle, and outputs a result of the determination as a sign determination signal; an angle counter that increments or decrements a count value of angular data represented by a predetermined bit length based on the sign determination signal, and outputs the count value as angular data; and a debounce unit that performs a debounce process on the angular data output by the angle counter.

According to still another aspect of the present invention, there is provided an angle detection method implemented by an angle detection device including a plurality of sensors, each being configured to output a sine wave signal that changes in a sine waveform according to a rotation angle of a rotating body and that has a different phase depending on an arrangement position of each of the sensors, and including an angle counter that performs a calculation on the sine wave signals output by the sensors and outputs an angle of the rotating body as angular data of a predetermined bit length, the angle detection method including: generating a vector based on the sine wave signals output by the sensors; rotating the vector by performing a calculation on the vector generated at the generating and reference sine waves with different phases; determining whether the vector rotated at the rotating is located in a positive direction or in a negative direction with respect to a predetermined reference angle; outputting a result of the determination at the determining as a sign determination signal; incrementing or decrementing a count value of the angular data based on the sign determination signal; and outputting the count value as angular data, wherein a deadband with a predetermined reference angle as a center is provided to determine one of the positive direction and the negative direction at the determining, and when the rotated vector is located in the deadband, the count value of the angular data is not incremented or decremented at the incrementing or decrementing.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an entire configuration of an angle detection device according to a first embodiment;

FIG. 2 is a diagram illustrating a UVW-phase sine wave signal;

FIG. 3 is a diagram illustrating transformation from a UV axis to an XY axis;

FIG. 4 is a diagram illustrating an X-axis signal and a Y-axis signal;

FIG. 5 is a diagram illustrating sine data and cosine data stored in a memory;

FIG. 6 is a diagram illustrating tracking of the X-axis by vector rotation, and a deadband according to the first embodiment;

FIG. 7 is a timing diagram illustrating operation of an angle counter according to the first embodiment;

FIG. 8 is a diagram illustrating an entire configuration of an angle detection device according to a second embodiment;

FIG. 9 is a timing diagram illustrating operation of an angle counter according to the second embodiment;

FIG. 10 is a diagram illustrating chattering of a rotated vector according to the second embodiment;

FIG. 11 is a table illustrating a process performed by a decoding unit according to the second embodiment;

FIG. 12 is a timing diagram illustrating the operation performed by a debounce filter according to the second embodiment;

FIG. 13 is a diagram illustrating an entire configuration of an angle detection device according to a third embodiment;

FIG. 14 is a timing diagram illustrating operation of a debounce unit according to the third embodiment;

FIG. 15 is a diagram illustrating an arrangement configuration of a rotating body and a magnetism detection sensor according to a conventional technology;

FIG. 16 is a diagram illustrating waveforms of two-phase sine wave signals with a phase difference of 90′; and

FIG. 17 is a diagram illustrating an example of operation of an angle search algorithm according to the conventional technology.

### DETAILED DESCRIPTION OF THE PREFERRED EMBODIMENTS

Exemplary embodiments of an angle detection device will be explained below.

The angle detection device includes a plurality of sensors (01U and 01V), each of which outputs a sine wave signal that changes in a sine waveform according to a rotation angle of a rotating body and that has a different phase depending on an arrangement position of each of the sensors; a vector generating unit 40 that generates a vector based on the sine wave signals output by the sensors; a vector rotating unit (a rotation calculating unit 30) that performs a calculation on the vector and reference sine waves with different phases to thereby rotate the vector; a sign determining unit 10 that determines whether the vector rotated by the vector rotating unit is located in a positive direction or in a negative direction with respect to a predetermined reference angle, and outputs a result of determination as a sign determination signal; and an angle counter 20 that increments or decrements a count value of angular data of a predetermined bit length based on the sign determination signal, and outputs the count value as angular data. A deadband with a predetermined reference angle as a center is provided for a process performed by the sign determining unit to determine one of the positive direction and the negative direction, and when the rotated vector is located in the deadband, the angle counter does not increment or decrement the count value of the angular data.

Furthermore, an angle detection method according to an embodiment is implemented by an angle detection device that includes a plurality of sensors (01U and 01V), each of which outputs a sine wave signal that changes in a sine waveform according to a rotation angle of a rotating body and that has a different phase depending on an arrangement position of each of the sensors; and the angle counter 20 that performs a calculation on the sine wave signals output by the sensors and outputs an angle of the rotating body as angular data of a predetermined bit length. The angle detection method includes a vector generation process to generate a vector based on the sine wave signals output by the sensors; a vector rotation process to rotate the vector by performing a calculation on the vector generated through the vector generation process and reference sine waves with different phases; a sign determination process to determine whether the vector rotated through the vector rotation process is located in a positive direction or in a negative direction with respect to a predetermined reference angle, and to output a result of the determination as a sign determination signal; and a counting process to increment or decrement a count value of the angular data based on the sign determination signal and to output the count value as angular data. A deadband with a predetermined reference angle as a center is provided to determine one of the positive direction and the negative direction in the sign determination process, and when the rotated vector is located in the deadband, the count value of the angular data is not incremented or decremented.

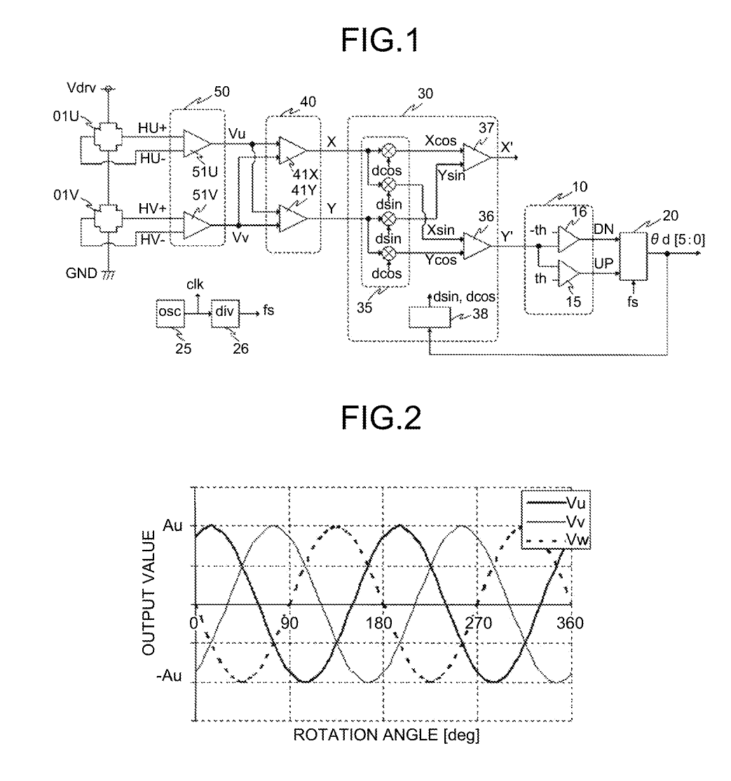

A configuration of the angle detection device will be explained below with reference to FIG. 1. FIG. 1 is a diagram illustrating an entire configuration of the angle detection device according to a first embodiment.

First, a plurality of sensors according to the embodiment will be explained. The sensors of the embodiment are Hall elements (01U and 01V) that detect magnetic fields.

The Hall element 01U is a magnetic sensor element arranged near a rotating body (not illustrated) including a permanent magnet, and includes, as illustrated in FIG. 1, two pairs of terminals such that a driving voltage is applied to one of the pairs and U-phase differential signals HU+ and HU− are output from the other one of the pairs. A difference between the U-phase differential signals HU+ and HU− corresponds to a sine waveform represented by the upper part of Equation 3 with respect to a rotation angle θ of the rotating body, and the amplitudes Au and Av are proportional to the Hall element sensitivities, a coefficient determined based on the magnitude of the magnetic field of the permanent magnet, and a driving voltage of the Hall elements.

$$\{ \begin{matrix}Vu = ( HU + ) - ( HU - ) = Au * sin ( θ + \frac{π}{3} ) \\ Vv = ( HV + ) - ( HV - ) = Av * sin ( θ - \frac{π}{3} )\end{matrix} \qquad ( 3 )$$

The Hall element 01V is arranged with a phase difference of 120° with respect to the Hall element 01U, has the same structure as the Hall element 01U, and outputs V-phase differential signals HV+ and HV− corresponding to a waveform represented by the lower part of Equation 3.

The pairs of the terminals of the Hall elements 01U and 01V to which the driving voltage is applied are connected in series as illustrated in FIG. 1, and one sides are connected to a driving voltage source Vdrv and the other sides are connected to ground GND via a resistor.

The configuration and operation of a differential unit 50 will be explained below. FIG. 2 illustrates waveforms of a U-phase sine wave signal Vu and a V-phase sine wave signal Vv output by the differential unit 50.

The differential unit 50 includes a U-phase differential amplifier 51U and a V-phase differential amplifier 51V.

The U-phase differential amplifier 51U is a subtractor using an operational amplifier and is configured to calculate a difference as represented by the upper part of Equation 3 and to output a result of the calculation as a U-phase sine wave signal Vu.

The V-phase differential amplifier 51V is a subtractor with the same configuration as the U-phase differential amplifier 51U and is configured to calculate a difference as represented by the lower part of Equation 3 and to output a result of the calculation as a V-phase sine wave signal Vv.

Incidentally, the differential amplifiers 51U and 51V may be configured to additionally calculate magnifications or values to offset the centers of the waveforms.

The above is the explanation of the differential unit 50. The U-phase sine wave signal Vu and the V-phase sine wave signal Vv output by the differential unit 50 have a phase difference of 120°, and ideally, correspond to the waveforms as illustrated in FIG. 2 with respect to the rotation angle θ.

Incidentally, in the waveforms illustrated in FIG. 2, the amplitudes Au and Av of the sine wave signals Vu and Vv are assumed to be the same for the simplicity sake.

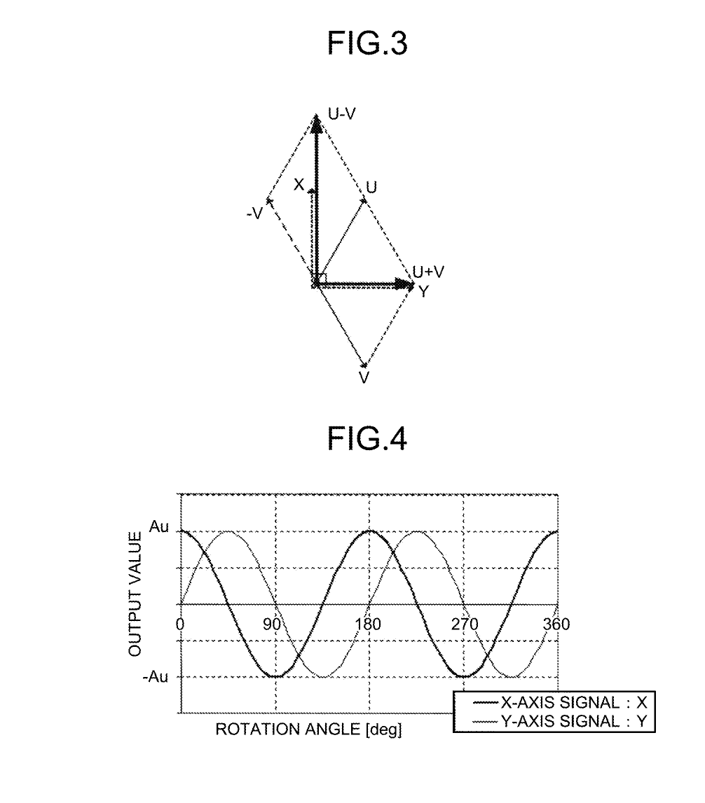

Next, the configuration and operation of the vector generating unit 40 serving as a vector generating means according to an embodiment of the present invention will be explained. FIG. 3 is a diagram illustrating axis transformation performed by the vector generating unit 40.

The vector generating unit 40 includes an X-axis generating unit 41X and a Y-axis generating unit 41Y, and generates an X-axis signal X and a Y-axis signal Y as two quadrature signals based on the sine wave signals Vu and Vv.

The X-axis generating unit 41X multiples a difference between the sine wave signals Vu and Vv by a magnification (1√3) as illustrated in the upper part of Equation 4, and outputs a result of the calculation as an X-axis signal X.

The Y-axis generating unit 41Y adds the sine wave signals Vu and Vv as illustrated in the lower part of Equation 4, and outputs a result of the calculation as the Y-axis signal Y.

The vector generating unit 40 is configured as described above. The operation of the vector generating unit 40 is to perform axis transformation as illustrated in FIG. 3 with respect to the U-phase signal and the V-phase signal, and the X-axis signal X and the Y-axis signal Y correspond to quadrature waveforms as illustrated in FIG. 4 and Equation 4 (vector generation process).

$$\{ \begin{matrix}X = ( Vu - Vv ) / \sqrt{3} = Au * cos ( θ ) \\ Y = Vu - Vv = Au * sin ( θ )\end{matrix} ( Au = Av ) \qquad ( 4 )$$

Furthermore, in the present embodiment, two quadrature signals X and Y are generated based on the two sine wave signals Vu and Vv with a phase difference of 120°. As long as the two quadrature signals X and Y can be obtained, it may be possible to perform addition or subtraction of two or more sine wave signals. Alternatively, if the sine wave signals Vu and Vv are originally quadrature signals, it may be possible to output the X-axis signal X and the Y-axis signal Y as they are.

Next, the configuration and operation of the rotation calculating unit 30 serving as a vector rotating means according to an embodiment of the present invention will be explained.

The rotation calculating unit 30 includes, as illustrated in FIG. 1, a multiplier 35, a Y-axis subtractor 36, an X-axis adder 37, and a memory 38, and is configured to perform rotation transformation on a vector represented by the X-axis signal X and the Y-axis signal Y in accordance with a value of angular data θd to be described later, and to output a rotation vector represented by a rotated X-axis signal X′ and a rotated Y-axis signal Y′ obtained as a result of the calculation.

The multiplier 35 multiplies, as represented by Equation 5, each of the X-axis signal X and the Y-axis signal Y by sine data d sin and cosine data d cos, and outputs calculation results X sin, X cos, Y sin, and Y cos.

$$\{ \begin{matrix}X sin = X * d sin \\ Y cos = Y * d cos \\ X cos = X * d cos \\ Y sin = Y * d sin\end{matrix} \qquad ( 5 )$$

The Y-axis subtractor 36 performs subtraction as represented by the lower part of Equation 6, and outputs a result of the calculation as a rotated Y-axis signal Y′ (vector rotation process).

The X-axis adder 37 performs addition as represented by the upper part of Equation 6, and outputs a result of the calculation as a rotated X-axis signal X′(vector rotation process). However, in the present embodiment, the rotated X-axis signal X′ is not used.

$$\{ \begin{matrix}{X}^{′} = X cos + Y sin \\ {Y}^{′} = - X sin + Y cos\end{matrix} \qquad ( 6 )$$

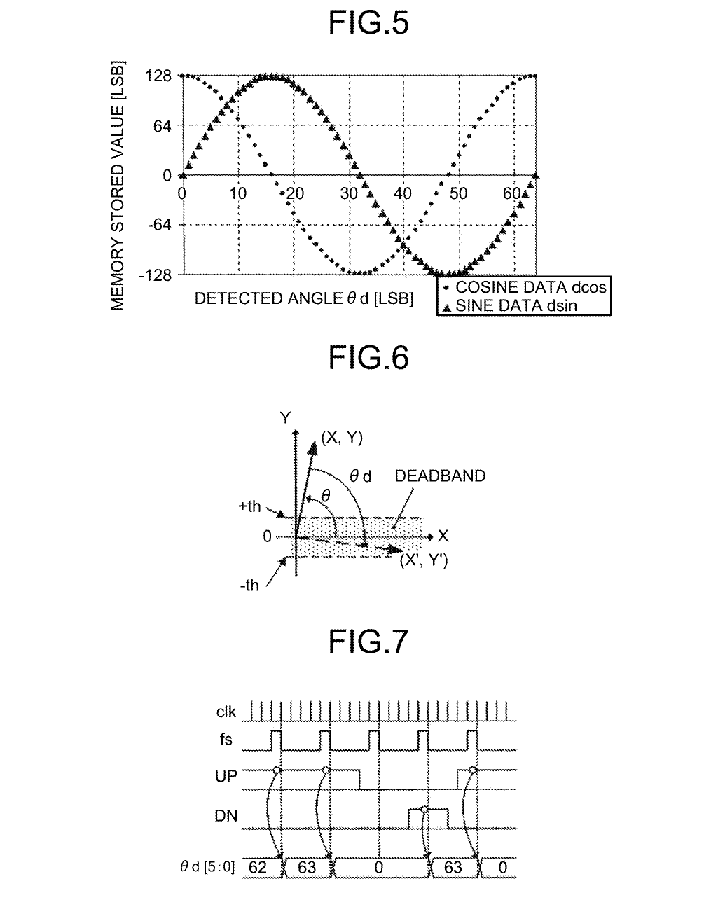

The memory 38 is a nonvolatile memory. As illustrated in FIG. 5, the memory 38 stores therein sine data d sin and cosine data d cos, in each of which one cycle is divided into 64 parts and the amplitude is represented by 127 lower sideband (LSB), and outputs corresponding data values according to the value of the angular data θd with a 6-bit word length to be described later.

Next, the configuration and operation of the sign determining unit 10 serving as a sign determining means according to an embodiment of the present invention will be explained. FIG. 6 illustrates tracking of the X-axis by vector rotation and illustrates a deadband.

The sign determining unit 10 includes, as illustrated in FIG. 1, an upside determining unit 15 and a downside determining unit 16. The sign determining unit 10 determines whether a rotated vector represented by the rotated X-axis signal X′ and the rotated Y-axis signal Y′ is located above or below a deadband with a width of (2×th) across the X-axis (Y′=0) serving as a target of rotation, and outputs a result of the determination as an upside determination signal UP or a downside determination signal DN (sign determination process).

The X-axis serving as the target of rotation as described above corresponds to a reference angle of the embodiment. Furthermore, the upside determination signal UP and the downside determination signal DN correspond to determination signals of the embodiment.

The upside determination signal UP is output as Hi when the rotated Y-axis data Y′ is equal to or greater than the width of the deadband on the positive side (+th) as represented by Equation 7 (sign determination process).

$$UP = \{ \begin{matrix}Hi & ( {Y}^{′} \geq th ) \\ Lo & ( {Y}^{′} < th )\end{matrix} \qquad ( 7 )$$

The downside determination signal DN is output as Hi when the rotated Y-axis data Y′ is equal to or smaller than the width of the deadband on the negative side (−th) as represented by Equation 8 (sign determination process).

$$DN = \{ \begin{matrix}Hi & ( {Y}^{′} \leq - th ) \\ Lo & ( {Y}^{′} > - th )\end{matrix} \qquad ( 8 )$$

An oscillator 25 outputs a clock clk that is a periodic pulse signal (see FIG. 1).

A frequency divider 26 divides the frequency of the clock clk and outputs a trigger fs (see FIG. 1).

Next, the operation of the angle counter 20 serving as an angle counter of the embodiment will be explained with reference to FIG. 7. FIG. 7 is a timing diagram illustrating the operation of the angle counter 20.

As illustrated in FIG. 7, the angle counter 20 increments the angular data θd by one count when the logic of the upside determination signal UP is Hi and decrements the angular data θd by one count when the logic of the downside determination signal DN is Hi every time the trigger fs arrives, and outputs the angular data θd (counting process). The two determination signals UP and DN do not become Hi simultaneously because of the setting of an upside reference value (+th) and a downside reference value (−th).

The angular data θd is an angle detection value obtained by the angle detection device, and is a repeat count with a 6-bit word length in the present embodiment. A relationship between the rotation angle θ and the angular data θd in this case is as follows.

θ (deg)=360 (deg)/64 (LSB)×θd (LSB)

The angular data θd corresponds to the angular data according to an embodiment of the present invention.

By configuring the rotation calculating unit 30, the sign determining unit 10, and the angle counter 20 as described above, the rotated vector represented by the rotated X-axis signal X′ and the rotated Y-axis signal Y′ is rotated by one count toward the X-axis serving as a target (reference angle) from the position of the original vector represented by the X-axis signal X and the Y-axis signal Y, and after the vector is rotated to a position close to the X-axis, the vector continuously tracks the X-axis. The amount of rotation from the original vector to the rotated vector corresponds to the angular data θd, and is a detection value of the rotation angle θ of the rotating body. This corresponds to angle detection using a tracking analog-to-digital (A/D) conversion method.

Incidentally, the sign determining unit according to the present embodiment is configured to provide a deadband near the X-axis as illustrated in FIG. 6, so that it becomes possible to prevent chattering, in which the angular data θd repeatedly changes from upside to downside and vice versa for each sampling period.

Namely, when the rotated vector near the X-axis (reference angle) enters the deadband, the sign determining unit 10 outputs Lo according to Equation 7 and Equation 8, so that the count value of the angular data θd is not incremented or decremented. Therefore, the vector rotating means does not rotate the vector, so that the angular data θd does not change from upside to downside and vice versa for each sampling period.

In the first embodiment, the angle detection device generates a vector based on output signals of the sensors configured to output multiple sine wave signals that change in sine waveforms according to the rotation angle of the rotating body and that have different phases, detects the rotation angle by performing rotation transformation on the vector, and includes a deadband for sign determination to determine a positive sign or a negative sign of the rotated vector with respect to the reference angle. Therefore, it becomes possible to prevent the detected angular data from changing for each sampling period.

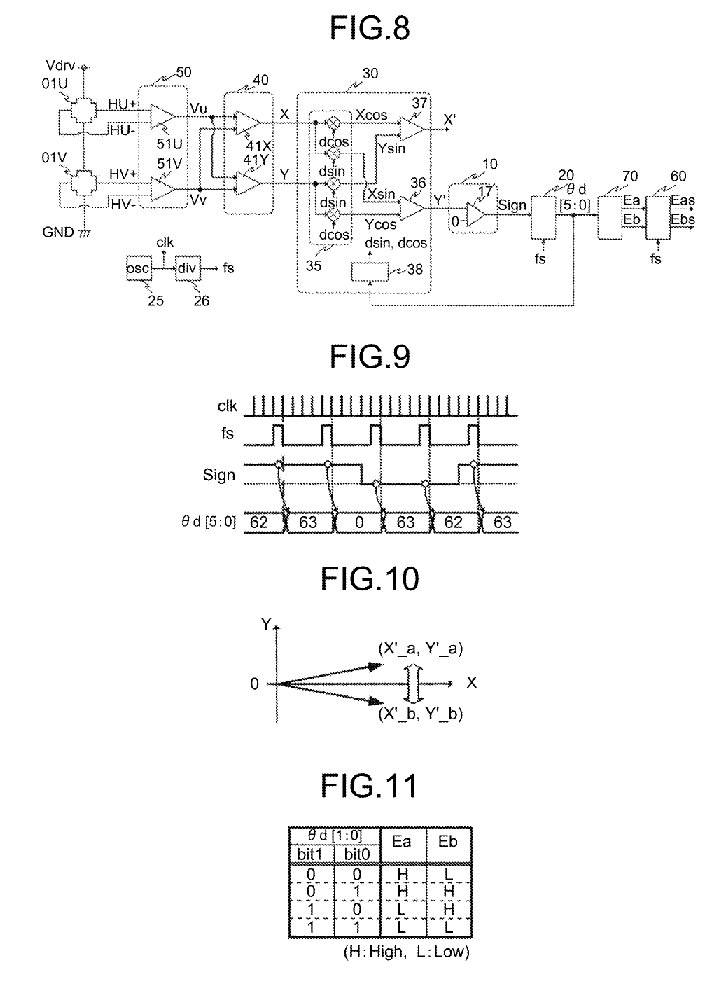

Next, a second embodiment will be explained with reference to FIG. 8. FIG. 8 is a diagram illustrating an entire configuration of an angle detection device according to the present embodiment. The Hall elements 01U and 01V, the oscillator 25, the frequency divider 26, the rotation calculating unit 30, the vector generating unit 40, and the differential unit 50 are the same as those of the first embodiment, and therefore, explanation thereof will be omitted. FIG. 9 is a timing diagram illustrating operation of the angle counter 20. FIG. 10 is a diagram illustrating chattering of a rotated vector. FIG. 11 illustrates a process performed by a decoding unit according to the present embodiment.

The configuration and operation of the sign determining unit 10 will be explained below.

The sign determining unit 10 determines, as illustrated in FIG. 8, the magnitude of the rotated vector represented by the rotated X-axis signal X′ and the rotated Y-axis signal Y′ with respect to the X-axis (Y′=0) serving as the target of rotation (reference angle), and outputs a result of the determination as a sign determination signal Sign.

The sign determination signal Sign is output as Hi when the rotated Y-axis data Y′ is equal to or greater than zero and is output as Lo when the rotated Y-axis data Y′ is smaller than zero as represented by Equation 9.

Incidentally, the sign determining unit 10 of the present embodiment serves as a sign determining means according to an embodiment of the present invention, and the sign determination signal Sign of the present embodiment serves as a sign determination signal according to an embodiment of the present invention.

$$Sign = \{ \begin{matrix}Hi & ( {Y}^{′} \geq 0 ) \\ Lo & ( {Y}^{′} < 0 )\end{matrix} \qquad ( 9 )$$

The operation of the angle counter 20 according to the present embodiment will be explained with reference to FIG. 9. FIG. 9 illustrates a timing diagram of the operation of the angle counter 20.

As illustrated in FIG. 9, the angle counter 20 increments the angular data θd by one count when the logic of the sign determination signal Sign is Hi and decrements the angular data θd by one count when the logic of the sign determination signal Sign is Lo every time the trigger fs arrives, and outputs the angular data θd.

The angular data θd is the same as that of the first embodiment.

In the configuration as described above, even when the rotating body is stopped, the rotated vector alternately changes between the two angles across the X-axis for each sampling period as illustrated in FIG. 10, so that the angular data θd changes for each sampling period. Therefore, in the present embodiment, a debounce means as described below is provided to prevent a change in the angular data.

First, a decoding unit 70 serving as a decoding means according to an embodiment of the present invention will be explained.

The decoding unit 70 refers to the lowest two bits of the angular data θd, and generates two-phase pulse signals Ea and Eb as illustrated in FIG. 11. Therefore, it becomes possible to indicate a change in the rotation angle of the rotating body and obtain the two-phase pulse signals Ea and Eb with a phase difference of one-fourth of a cycle, without providing an encoder.

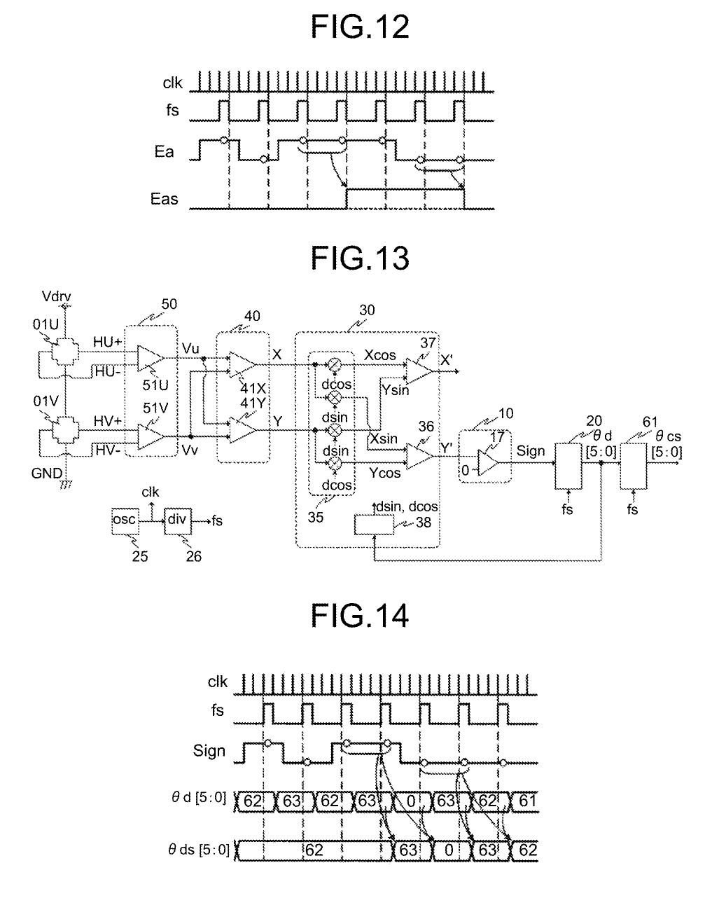

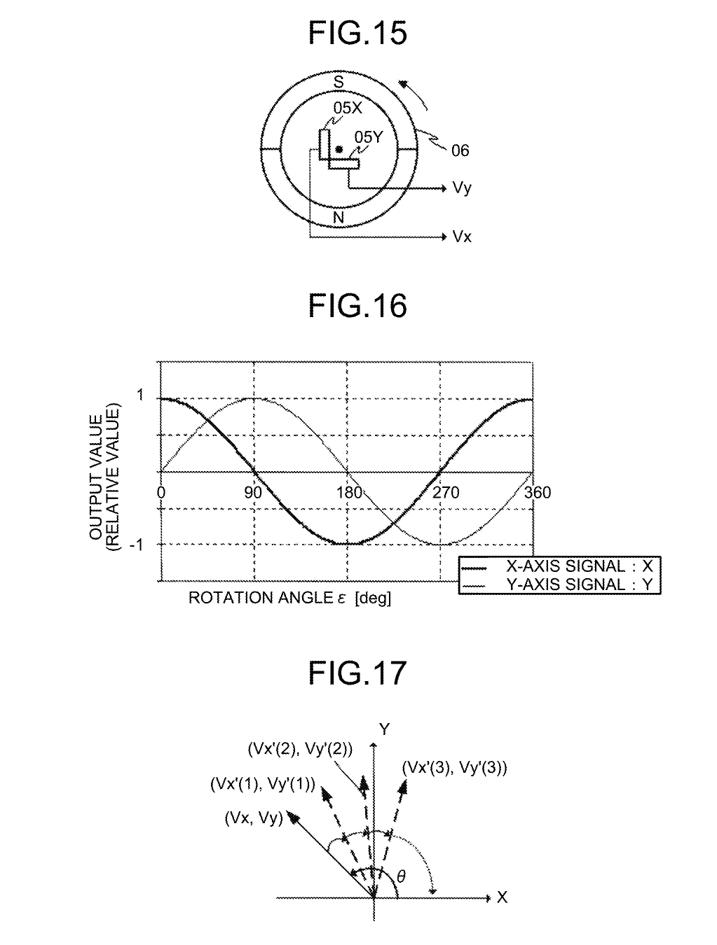

Next, the operation of a debounce filter 60 serving as a debounce means according to an embodiment of the present embodiment will be explained with reference to FIG. 12.

As illustrated in FIG. 12, the debounce filter 60 monitors the two-phase pulse signal Ea every time the trigger fs arrives. When the logic of the two-phase pulse signal Ea has changed, and if the logic has not changed two or more consecutive times, the debounce filter 60 reflects the change in a corrected two-phase pulse Eas and outputs the corrected two-phase pulse Eas. The same operation is performed on the two-phase pulse signal Eb.

In the second embodiment, the decoding unit 70 is provided to generate and output the two-phase pulse signals indicating a change in the rotation angle based on the lowest two digits of the detected angular data, and the debounce filter 60 is provided to perform a debounce process on the two-phase pulse signals. Therefore, it becomes possible to generate two-phase pulse signals while preventing chattering.

Next, a third embodiment will be explained with reference to FIG. 13. FIG. 13 is a diagram illustrating an entire configuration of an angle detection device according to the present embodiment. Incidentally, the same explanation as those of the first and the second embodiments will not be repeated. The Hall elements 01U and 01V, the sign determining unit 10, the angle counter 20, the oscillator 25, the frequency divider 26, the rotation calculating unit 30, the differential unit 50, and the vector generating unit 40 are the same as those of the first embodiment, and therefore, explanation thereof will be omitted.

A debounce unit 61 serving as a debounce means according to an embodiment of the present invention will be explained below.

As illustrated in FIG. 14, the debounce unit 61 monitors the value of the angular data θd every time the trigger fs arrives. When the value of the angular data θd has changed, and if the value of the angular data θd has not changed back to the original value, the debounce unit 61 employs the changed count value as corrected angular data θds and outputs it as the angular data.

The corrected angular data θds of the present embodiment corresponds to angular data according to an embodiment of the present invention.

In the third embodiment, as illustrated in FIG. 14, the debounce unit 61 employs the changed count value and outputs it as the corrected angular data θds only when the count value of the angular data θd that changes for each sampling period has changed but has not changed back to the original value within a predetermined time. Therefore, it becomes possible to prevent the lowest digit of the angular data from changing for each sampling period.

In the angle detection device that detects the rotation angle of the rotating body based on the output signals of the sensors configured to output multiple sine wave signals with different phases that change in the sine waveforms according to the rotation angle, it becomes possible to prevent the lowest digit of the detected angular data from changing for each sampling period, and prevent chattering or a change in the pulse while the rotation is stopped even when the pulse signal indicating an angular change is generated based on the angular data.

According to the angle detection device of an embodiment of the present embodiments, a deadband with a predetermined reference angle as a center is provided for a process performed by the sign determining unit to determine one of the positive direction and the negative direction. Therefore, when the rotated vector is located in the deadband, the count value of the angular data is not incremented or decremented near the reference angle, so that it becomes possible to prevent the angular data from changing for each sampling period.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An angle detection device comprising:
a plurality of sensors, each being configured to output a sine wave signal that changes in a sine waveform according to a rotation angle of a rotating body and that has a different phase depending on an arrangement position of each of the sensors;
a vector generating unit that generates a vector based on the sine wave signals output by the sensors;
a vector rotating unit that performs a calculation on the vector and reference sine waves with different phases to thereby rotate the vector;
a sign determining unit that determines whether the vector rotated by the vector rotating unit is located in a positive direction or in a negative direction with respect to a predetermined reference angle, and outputs a result of the determination as a sign determination signal; and
an angle counter that increments or decrements a count value of angular data of a predetermined bit length based on the sign determination signal, and outputs the count value as angular data, wherein
a deadband with a predetermined reference angle as a center is provided for a process performed by the sign determining unit to determine one of the positive direction and the negative direction, and
when the rotated vector is located in the deadband, the angle counter does not increment or decrement the count value of the angular data.

2. An angle detection device comprising:
a plurality of sensors, each being configured to output a sine wave signal that changes in a sine waveform according to a rotation angle of a rotating body and that has a different phase depending on an arrangement position of each of the sensors;
a vector generating unit that generates a vector based on the sine wave signals output by the sensors;
a vector rotating unit that performs a calculation based on the vector and reference sine waves with different phases to thereby rotate the vector;
a sign determining unit that determines whether the vector rotated by the vector rotating unit is located in a positive direction or a negative direction with respect to a predetermined reference angle, and outputs a result of the determination as a sign determination signal;
an angle counter that increments or decrements a count value of angular data represented by a predetermined bit length based on the sign determination signal, and outputs the count value as angular data; and
a debounce unit that performs a debounce process on the angular data output by the angle counter.

3. The angle detection device according to claim 2, further comprising:
a decoding unit that generates and outputs a pulse signal based on a value of the angular data with predetermined digits output by the angle counter, wherein
the debounce unit is a debounce filter that, when a logic of the pulse signal has not changed a predetermined number of times, outputs a corrected pulse signal in which a change in the pulse signal is reflected.

4. The angle detection device according to claim 2, wherein when the count value of the angular data has changed but has not changed back to an original value within a predetermined time, the debounce unit employs and outputs the changed count value as the angular data.

5. An angle detection method implemented by an angle detection device comprising a plurality of sensors, each being configured to output a sine wave signal that changes in a sine waveform according to a rotation angle of a rotating body and that has a different phase depending on an arrangement position of each of the sensors, and including an angle counter that performs a calculation on the sine wave signals output by the sensors and outputs an angle of the rotating body as angular data of a predetermined bit length, the angle detection method comprising:
generating a vector based on the sine wave signals output by the sensors;
rotating the vector by performing a calculation on the vector generated at the generating and reference sine waves with different phases;
determining whether the vector rotated at the rotating is located in a positive direction or in a negative direction with respect to a predetermined reference angle;
outputting a result of the determination at the determining as a sign determination signal;
incrementing or decrementing a count value of the angular data based on the sign determination signal; and
outputting the count value as angular data, wherein
a deadband with a predetermined reference angle as a center is provided to determine one of the positive direction and the negative direction at the determining, and
when the rotated vector is located in the deadband, the count value of the angular data is not incremented or decremented at the incrementing or decrementing.
